(19) United States
(12) Patent Application Publication
(10) Pub. No.: US 2010/0288700 A1
(43) Pub. Date: Nov. 18, 2010

(54) POST TREATMENT OF DESALINATED AND SOFT WATER FOR BALANCED WATER COMPOSITION SUPPLY

(75) Inventors: Ori Lahav, Nesher (IL); Liat Birnhack, Nesher (IL)

Correspondence Address: William H. Dippert;Eckert Seamans Cherin & Mellott, LLC, U.S. Steel Tower, 600 Grant Street, 44th Floor, Pittsburgh, PA, 15219, US

(73) Assignee: TECHNION RESEARCH & DEVELOPMENT FOUNDATION LTD., Haifa (IL)

(21) Appl. No.: 12/467,633

(22) Filed: May 18, 2009

Related U.S. Application Data
(63) Continuation-in-part of application No. 12/446,393, filed on Apr. 20, 2009.

(51) Int. Cl. C02F 1/42

(52) U.S. Cl. 210/638; 210/687

(57) ABSTRACT

A calcite dissolution post-treatment process and apparatii for desalinated water are provided. The process comprises separating cations from seawater or brackish/seawater desalination brines by ion exchange resin(s) onto which the ions are loaded, contacting the ion exchange resin(s) loaded with the cations with an effluent of a calcite dissolution reactor wherein the cations are exchanged with Ca²⁺ from this effluent. The Ca²⁺ concentration of the resulting desalinated water decreases while the cations concentration increases to comply with required quality criteria. Batch type and continuous apparatii by which the process can be carried out are described.

### CROSS-REFERENCE TO RELATED APPLICATION

This application is a Continuation In Part of U.S. patent application Ser. No. 12/446,393 filed Apr. 20, 2009, the entire contents of which is incorporated by reference as if fully set forth herein.

### FIELD OF THE INVENTION

The present invention relates to desalinated and soft waters. More particularly, the present invention relates to post treatment of desalinated water and soft water for supply of balanced water composition, which includes supply of calcium, magnesium and carbonate ions in the water and in certain cases also sulfate ions, along with a required pH and total hardness values.

### BACKGROUND OF THE INVENTION

Desalination of seawater and brackish water is receiving increased attention worldwide. The percentage of desalinated water out of the total water supply in many countries is currently increasing and will further significantly increase in the near future. Two main types of industrial desalination processes are currently implemented: reverse osmosis (RO) technologies and electro-dialysis technologies. All desalination processes result in water that is very low in dissolved solids. Naturally occurring soft waters are also encountered in many places. In order to improve the quality of these water sources, further treatment is needed (in desalinated water, the water is treated following the membrane separation step and thus this step is termed “post treatment”). Water low in dissolve substances tastes insipid, but more importantly, it tends to be corrosive to water distribution pipes, which are typically made of metal. Corrosion of metal pipes results in both shortened infrastructure life time and also in a constant release of dissolved metal ions and colloid metal particles into the water, and therefore to the consumer's tap. In order to be able to use the water as drinking water, soft waters and effluent from desalination plants has to be treated to stabilize the water. Additionally, in most places, drinking water is expected to supply certain minerals that are essential for human health, e.g. Ca²⁺ and Mg²⁺ ions, and agricultural irrigation supplements such as Ca²⁺, Mg²⁺ and SO₄²⁻ ions. In some occasions, the total hardness of the water (i.e. in practical terms, the sum of [Mg²⁺] and [Ca²⁺]) may also be limited due to economic reasons.

Desalinated water is invariably required to be post treated (“Larnaca Desalination Plant”, by B. Liberman in Desalination 138 (2001), 293-295) to comply with a certain, required, chemical quality; However, to date, no formal regulation exists worldwide that defines unequivocally the quality of desalinated water. However, the water is expected to conform to the general water quality requirements. In Israel, the following set of quality criteria for desalinated water was adopted in January 2006 by the Committee for the Update of Israel's water regulations nominated by the Israeli Ministry of Health (the criteria, unique in the world, are expected to come into effect in the near future):
1. Alkalinity (H₂CO₃* alkalinity)>80 mg/L as CaCO₃
2. 80<Ca²⁺<120 mg/L as CaCO₃
3. 3<CCPP*<10 mg/L as CaCO₃
4. pH<8.5
   *CCPP stands for Calcium Carbonate Precipitation Potential.

The choice of the post-treatment process to be applied in the desalination plant is determined primarily by the water quality required and by economic considerations. Two main groups of post treatment processes are typically implemented for soft waters and desalination plant effluents: (1) processes that center around CaCO₃₍ₛ₎ dissolution for both alkalinity and Ca²⁺ supply and (2) processes that are based on direct dosage of chemicals. The latter group is less often implemented because of economical reasons and will thus not be discussed further.

Calcite dissolution processes are cost effective in places where calcite abounds in nature and can be easily extracted. In order to enhance calcite dissolution kinetics and to increase the capacity of the water to dissolve CaCO₃₍ₛ₎, water pH must be reduced before it is introduced into the calcite reactor. Two acidic substances are typically used to lower the pH value: H₂SO₄ and CO_{2(g)}. The advantage of using a strong acid such as H₂SO₄ is that pH can be lowered to any desired value, which results in rapid CaCO₃ dissolution kinetics. As a result, it is possible to pass only a fraction of the water through the calcite column, and blend it with the untreated fraction thereafter. To determine the final pH (and the final CCPP value) NaOH is dosed to the blend prior to its discharge. The process is depicted schematically in FIG. 1 that illustrates a typical calcite-dissolution-based post treatment using H₂SO₄ for pH reduction. This post treatment process is currently practiced, for example, in the 100,000,000 m³/year desalination plant in Ashkelon, Israel.

The main advantage of this method is that it requires a relatively small calcite packed bed reactor, the application of the acid is simple and inexpensive, and the process is thus relatively cheap. Disadvantages include the release of a substantial amount of SO₄²⁻ to the water (may also be considered an advantage if the water is used for agricultural irrigation), and potential gypsum precipitation if the process is operated improperly. However, the most significant drawback associated with this process is that it is bound to yield a ratio of approximately 2 to 1 between the Ca²⁺ and alkalinity concentrations in the effluent, and sometimes even a higher ratio (both parameters in units of mg/L as CaCO₃). As a consequent, meeting the demand for an alkalinity concentration of >80 mg/L as CaCO₃ results in a high Ca²⁺ (and thus total hardness) concentration, higher than the upper limit of 120 mg/L as CaCO₃ required by the new Israeli criteria, as an example. In other words, meeting the alkalinity value yields water that is excessively hard. Similarly, if the Ca²⁺ concentration is maintained below the upper limit (i.e. below 120 mg/L as CaCO₃), the alkalinity concentration in the effluent will be below the recommended value and the buffering capacity of the water will be low, rendering the water less chemically stable. Consequently, the process depicted in FIG. 1 cannot be implemented to meet such stringent quality criteria.

The reason for the approximate 2 (Ca²⁺) to 1 (alkalinity) ratio is as follows: to be cost effective, concentrated H₂SO₄ is typically dosed to the water to lower pH to a pH value between 2.2 and 2.5, just before the water enters the calcite reactor (see FIG. 1). The flow regime in the calcite reactor resembles vertical plug flow (either upward or downward). Along its flow through the calcite reactor CaCO₃ dissolves and the water collects both Ca²⁺ and CO₃²⁻ ions. Because of the low to neutral pH that prevails throughout the calcite reactor, CO₃²⁻ is instantaneously transformed to HCO₃⁻ and/or H₂CO₃*, and in parallel pH goes up. At the end of the process, the water leaves the calcite reactor at a pH close to 7.0. After blending with the split flow (see FIG. 1) pH is raised to the final pH (between 8.0 and 8.3) by dosage of a concentrated NaOH solution.

The result of this process is that the Ca²⁺ concentration expressed in the units “mg/L as CaCO₃” is always about twice that of the alkalinity expressed in the same units. Simply put, under these conditions, around 50% of the proton accepting capacity of the CO₃²⁻ that originates from dissolving the calcite solid is used for raising pH from the initial pH value to a pH value around 4.5 that is typically used as the end point for H₂CO₃* alkalinity determination. This proton accepting capacity is therefore not accounted for in the alkalinity determination procedure.

In the second prevalent calcite dissolution process, CO_{2(g)} is added in order to acidify the water prior to its introduction into the calcite reactor. The main advantage of the process is that the resultant Ca²⁺ to alkalinity ratio tends towards 1 to 1 (both parameters expressed in mg/L as CaCO₃) and thus both parameters can be attained at similar concentrations, which allows attaining the alkalinity and calcium criteria at the same time. The main disadvantage of this process is that CO₂ addition can reduce pH to not lower than around pH 4.0, and thus calcite dissolution kinetics are slower than with H₂SO₄. Consequently, a larger percentage of the water has to be passed through the calcite reactor, and thus larger reactor volumes are required. Another disadvantage is that the application of the CO_{2(g)} as an acidic substance is more expensive than that of H₂SO₄. As a result, in terms of cost effectiveness, the operation of the method that uses H₂SO₄ as the acidic substance is typically cheaper than the method that utilizes CO_{2(g)}. However, in certain places around the world the CO_{2(g)} based post treatment is more common than the H₂SO₄-based process and in many desalination plants (in the Tampa Bay, Fla. plant, as an example) it is implemented.

Another significant drawback associated with both calcite dissolution processes is that they result in no addition of Mg²⁺ ions to the water. Mg²⁺ ions, although not included in the current Israeli quality criteria, are very much welcome in desalinated water for both agricultural and human health reasons. In its most recent Water Quality Guidelines, the WHO refers to the 2009 WHO publication “Calcium and Magnesium in Drinking Water” in which it is stated that “Desalination stabilization processes should ensure that the overall process does not significantly reduce total intake of nutrients such as calcium, magnesium and fluoride.” Post treatment processes that are based on calcite dissolution cannot, naturally, supply Mg²⁺ ions. Other options such as dolomite rock (MgCa(CO₃)₂) dissolution or direct chemical dosage are either expensive (both processes) or result in a high total hardness concentration or a high counter anion concentration (typically chloride ions), respectively.

### SUMMARY OF THE INVENTION

It is an object of the present invention to provide additional step(s) to either H₂SO₄-based calcite dissolution post-treatment process or CO_{2(g)}-based calcite dissolution post-treatment process that would enable their implementation along with the supply of cheap Mg²⁺ ions originating from either seawater or brackish water or the brine of brackish or seawater desalination operations, while fully conforming to the other required criteria.

It is another object of the present invention to provide an apparatus for post-treatment of desalinated and soft waters from which the resulting water is enriched with cheap Mg²⁺ ions originating from seawater or brackish water or desalination-process brine and is fully conforming to other required criteria including (if required) a threshold hardness concentration.

It is therefore provided in accordance with a preferred embodiment of the present invention an H₂SO₄-based or CO_{2(g)}-based calcite dissolution post-treatment process for water such as seawater, brackish or seawater desalination-process brine or any other cations-rich solution comprising:

separating cations from said water by at least one type of ion exchange resin onto which said ions are loaded;

an effluent of a calcite reactor wherein said cations are exchanged with Ca²⁺ from said calcite reactor effluent;

where in the Ca²⁺ concentration of the resulting desalinated water decreases while the cations concentration increases to comply with required quality criteria.

Furthermore in accordance with another preferred embodiment of the present invention, the process further comprises rinsing said ion exchange resin with an internal desalination-plant water stream low in dissolved solids and draining it thereafter.

Furthermore in accordance with another preferred embodiment of the present invention, said cations are Mg²⁺, K⁺ and Na⁺ and wherein Mg²⁺ ions are being exchanged in a first type ion exchange resin and Na⁺ and K⁺ ions in a second type ion exchange resin.

Furthermore in accordance with another preferred embodiment of the present invention, said first type ion exchange resin has a high affinity towards divalent cations such as Mg²⁺ and Ca²⁺ and an extremely low affinity towards monovalent cations such as Na⁺ and K⁺.

Furthermore in accordance with another preferred embodiment of the present invention, said second type ion exchange resin has a high affinity towards monovalent cations such as Na⁺ and K⁺ and a relatively low affinity towards divalent cations such as Ca²⁺ and Mg²⁺.

Furthermore in accordance with another preferred embodiment of the present invention, said first type ion exchange resin is a resin such as Amberlite IRC747 (Rohm & Hass INC.) or equivalent.

said water used to load the resin with cations is filtered water before it enters desalination process.

Furthermore in accordance with another preferred embodiment of the present invention, the water used to load the resin with said cations is pre-filtered using sand filtration or UF membranes.

Furthermore in accordance with another preferred embodiment of the present invention, said water that is used to load the resin is returned back to a container from where it was taken in a closed loop manner or discarded.

Furthermore in accordance with another preferred embodiment of the present invention, the process is carried out in a batch ion-exchange mode.

Furthermore in accordance with another preferred embodiment of the present invention, the process is carried out in a continuous ion exchange mode.

Furthermore in accordance with another preferred embodiment of the present invention, the required quality criteria is Alkalinity (H₂CO₃* alkalinity) greater than 80 mg/L as CaCO₃; Ca²⁺ higher than 80; Calcium Carbonate Precipitation Potential between 3 and 10 mg/L as CaCO₃ and pH of less than 8.5.

Furthermore in accordance with another preferred embodiment of the present invention, the process can be implemented in order to replace any certain fraction of the Ca²⁺ concentration generated by H₂SO₄- or CO₂-based calcite dissolution processes (or a combination of both acidic agents) by an equivalent cations concentrations.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 schematically illustrates a typical calcite-dissolution-based desalination post treatment using H₂SO₄ or CO_{2(g)} for pH reduction (PRIOR ART).

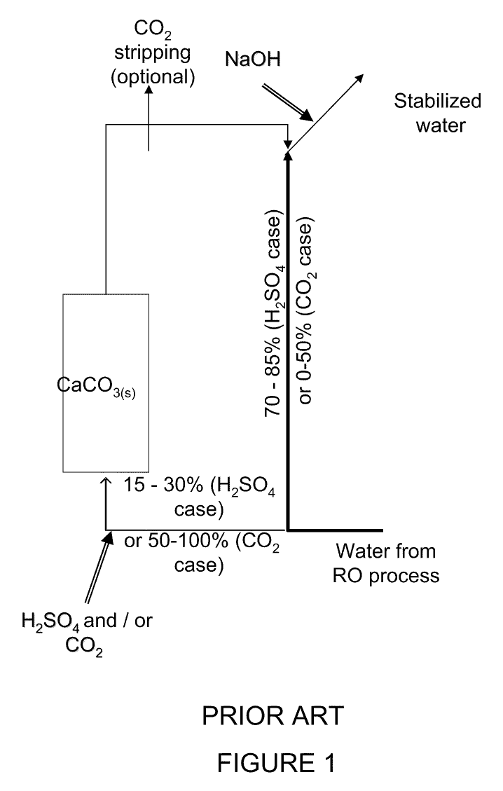

FIG. 2 schematically illustrates a calcite-dissolution-based desalination post treatment process in accordance with a preferred embodiment of the present invention (batch ion exchange operation).

FIG. 3 schematically illustrates a calcite-dissolution-based desalination post treatment process in accordance with another preferred embodiment of the present invention (continuous ion exchange operation).

FIG. 4 schematically illustrates an H2SO4 Calcite-dissolution-based desalination post treatment process operating in parallel to two sets of ion-exchange columns in accordance with yet another preferred embodiment of the present invention.

### DETAILED DESCRIPTION OF THE INVENTION

The present invention provides a new and unique post treatment process to be used after brackish water or seawater desalination or to be applied to naturally occurring soft waters. The present invention may be used to treat any soft water type. Desalinated water is an example for such water. The post treatment process in accordance with the present invention makes use of currently employed post-treatment process (i.e. calcite dissolution using either H₂SO₄ or CO_{2(g)} or a combination of both), and at the same time results in a Ca²⁺ (and possibly total hardness) concentration in the effluent that complies with stringent water criteria regulations (in terms of alkalinity, CCPP and pH) in addition to a significant supply of dissolved Mg²⁺ in the product water, while fully conforming to the other required criteria.

Optionally, seawater as a source of cations may be replaced inland with either locally produced brine from an inland desalination plant, raw brackish water containing a favorable Mg²⁺ concentration and favorable Mg²⁺:Ca²⁺ ratio, or magnesium-containing solid salts. As an example for the latter, a certain salt product from the Dead Sea in Israel contains 25% Mg²⁺ by mass and can be used for this purpose.

The invention hinges around replacing the excessive Ca²⁺ ions generated in calcite dissolution processes by Mg²⁺ (and possibly Na⁺ and K⁺ ions, if a restriction on total hardness is imposed) ions originating from a magnesium-rich source, i.e. seawater, desalination brines, brackish water or solid Mg²⁺ (and/or Na⁺ and/or K⁺ ions)-containing salts. First, Mg²⁺ ions, for example, are separated from the Mg²⁺-rich source (e.g. seawater) by means of an ion exchange resin that has a high affinity towards divalent cations (Mg²⁺ and Ca²⁺) and an extremely low affinity towards monovalent cations (Namely Na⁺ and K⁺). Second, the Mg²⁺-loaded resin is contacted with a certain portion of the effluent of the calcite reactor. In this step, Mg²⁺ and Ca²⁺ are exchanged. Consequently, the Ca²⁺ concentration of the water decreases while the Mg²⁺ concentration increases to comply with the required quality criteria. If a restriction on total hardness is imposed, a certain Ca²⁺ portion should also be replaced with monovalent cations such as Na⁺ and K⁺. In such a case, a second ion exchange resin, having a high affinity towards Na⁺ and K⁺ and a low affinity towards Ca²⁺ and Mg²⁺ is used to load Na⁺ and K⁺ from the cation solution (e.g. seawater, RO brine, etc.). This resin is thereafter contacted with a certain portion of the calcite reactor effluent whereby a predetermined Ca²⁺ concentration is replaced with Na⁺ and K⁺.

All the water streams used in the ion exchange processes are preferably internal streams that form a part of the desalination plant sequence regardless of the additional ion exchange processes. For example, the stream used to load the resins with Mg²⁺, Na⁺ and K⁺ ions may be either the filtered seawater before it enters the membrane process or a brine from the RO desalination step. The water that is used to load the resin is returned back to the container from where it was taken (in case of seawater or brackish water brine) or discarded back to the sea (in the case of seawater brine).

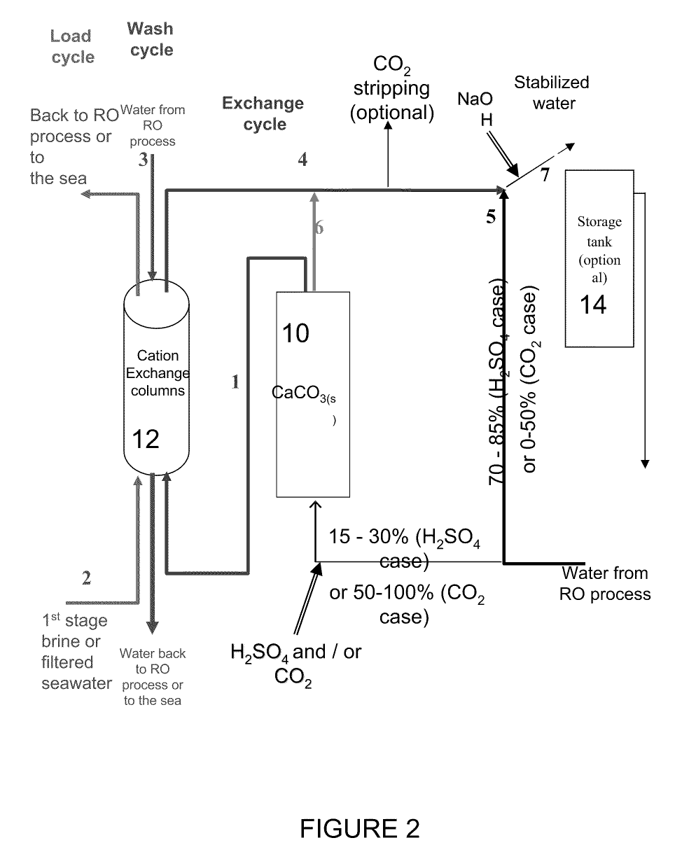

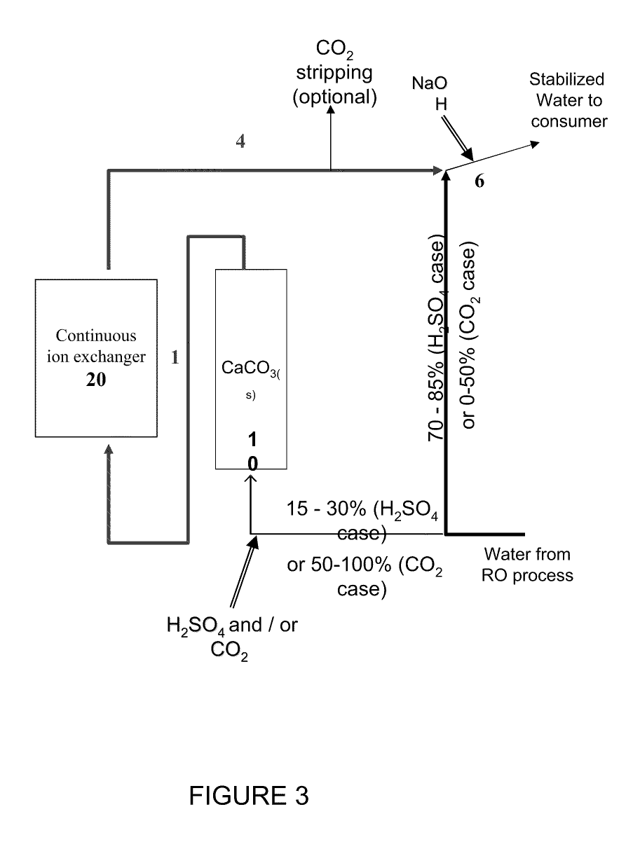

Reference is now made to FIG. 2 and FIG. 3 that schematically illustrate a calcite-dissolution post treatment process that includes an ion exchange reactor (could be also several reactors filled with one or more resin types) in accordance with a preferred embodiment of the present invention. The process in accordance with the present invention can be carried out in either a batch mode as illustrated in FIG. 2 or in a continuous mode as illustrated in FIG. 3. Batch mode operation (which is by definition a non steady state operation) may be preferred in cases where the desalinated water is stored in a sufficiently large downstream storage tank prior to discharge, where the product water is mixed, or when multiple columns are used and timed in such a way to produce a close to constant water quality product with time. Alternatively, when no storage exists, the preference may be to apply a continuous ion exchange process (i.e. steady state operation) that allows for the discharge of water with quality parameters that do not change with time.

A simplified scheme of exemplary batch operation mode is depicted in FIG. 2. In the batch operation mode, a number of ion exchange columns are operated intermittently (classical ion exchange operation), i.e. a control system is used to switch the columns' mode between an Exchange mode, a Load mode and a Rinse mode. During the Exchange mode, Ca²⁺ ions from the water flowing from a calcite reactor 10 (the stream is indicated by #1 in FIG. 2) are exchanged with Mg²⁺ (and Na⁺ or K⁺, if required) ions from a resin that is placed within a cation exchange column 12. In the Load mode, seawater or, alternatively, brackish or seawater brine (indicated by stream #2) is used to load fresh Mg²⁺ (Na⁺, K⁺) ions onto the resins in cation exchange column 12. In the Rinse mode, which is the shortest mode, brine water low in dissolved solids (stream #3) (from the desalination process) is used to wash the resin from residual loading solution (either seawater or RO brine).

Optionally, this step is followed by pressurized-air assisted drainage aimed at minimizing the chance that components from the loading solution would be found in the product water.

Optionally, another technique to minimize the enrichment of the product water with components from the loading solution is to drain the loading solution (using pressurized-air assisted drainage). This way, the time consumed by the Rinse step is reduced, and the need for brine with low Total Dissolved Solids (TDS) for rinsing purposes, is avoided. The additional average salinity added to the product water (in the Exchange mode that follows the Wash mode) due to residual water from the Load mode would not exceed a TDS value of approximately 5 mg/L and the boron concentration addition due to the wash step should not exceed a value of 0.1 mg/L. Following the Rinse mode, the rinsing water is pumped back to the point in the RO process from which it was taken or discarded. The effluent from the Exchange mode (stream #4), is recombined with the split flows (either raw desalinated water alone, or a combination of raw desalinated water and calcite reactor effluent) (indicated by #5 and #6, respectively), and NaOH is added to the combined flow to attain the required pH and CCPP values. In order to avoid irregularity in water quality (due to the unsteady state nature of the batch ion exchange operation), the effluent of the process (indicated by stream #7), may be mixed in a storage tank 14 to yield the required water quality prior to discharge, or alternatively multiple ion exchange columns are operated in a controlled manner as to produce a close to constant water quality.

Reference is now made to FIG. 3 illustrating a continuous ion-exchange operation in accordance with a preferred embodiment of the present invention. In the term “continuous ion exchange process” are included all possible technical alternatives of such technology (e.g. CSTR reactors with gravity resin separation, rotary continuous systems, patented systems such as Calgon's ISEP® Continuous Contactor, and equivalents) in which the steps: ion exchange, rinse, and regeneration are carried out simultaneously, and effluent quality is thus constant in time. In the present invention, the resin passes periodically between three distinct zones: a “load zone”; a “rinse zone”; and an “exchange zone”. The time the resin spends in each zone is determined according to the specific requirements of the process, but typically the resin will remain in the Exchange zone for about 85% of the time, in the Load zone for about 10% of the time, and in the Rinse zone for about 5% of the time. In the “Load zone”, filtered seawater or brackish water (or brine from the desalination plant whose concentration is higher than the raw water entering the desalination process) is passed through a specific cationic ion exchange resin 20 and Mg²⁺ (and Na⁺ or K⁺) ions from the cation-rich solution (e.g. seawater, RO brine, etc.) are absorbed onto the resins. The water that serves to load the resins is returned back to the RO process or discarded as originally planned in the RO process, thus no further waste is generated.

After leaving the Load zone, the resin passes on to the Rinse zone in which it is rinsed by water low in TDS originating from the desalination process (e.g. the brine of one of the RO process stages that has a relatively low salinity, for example the brine from the 2^{nd} or 4^{th} stage in the Ashkelon (Israel) desalination plant). After rinsing the resin and draining the water from it, the rinsing water is returned to the RO process, thus again no waste is generated. The time that the resin spends in the rinse zone (and the rinsing water flow rate) is planned in such a way that the salinity added to the product water due to water remaining in the bed that originated from the Load zone would not exceed an average Total Dissolved Solids (TDS) value of approximately 5 mg/L. The resin that leaves the Rinse zone is conveyed to the “Exchange zone” to which the effluent of the calcite dissolution process is pumped. In this zone, the surplus dissolved Ca²⁺ ions generated in the calcite dissolution process are exchanged (equivalent per equivalent) with Mg²⁺, Na⁺ or K⁺ ions adsorbed on the resins (see example below). The water that leaves the Exchange zone is recombined with the split soft water stream to yield the final required Ca²⁺, Mg²⁺, and hardness (if required) concentrations. Finally, NaOH is dosed to the combined stream to attain a required pH (and CCPP) value.

There are two main advantages to the modification of the calcite dissolution process that is suggested in the invention: the addition of the ion exchange part allows using the H₂SO₄ based process (which is much cheaper than the alternatives) without surpassing the Ca²⁺ concentration limit set by the new criteria or generating water that is rich in total hardness. At the same time, the process allows the supply of cheap Mg²⁺ ions to the water, and also the supply of water that is not excessively hard. Furthermore, the process generates no waste streams since all the water required to both load the resin and wash it comes from within the RO process and returns to it without inversely affecting the membrane separation process itself.

Although the use of H₂SO₄ may be preferred for calcite dissolution (according to current cost of chemicals in 2009 and from both simplicity and overall cost effectiveness, and also because it provides SO₄²⁻ ions in the water, required for plant irrigation) the described process can be implemented also with the two other prevalent desalination post-treatment processes, i.e. calcite dissolution using CO_{2(g)} as the acidic substance, and the process that is based on dosing of Ca(OH)₂ followed by the addition of CO_{2(g)}.

Optionally, the process of Mg2+ addition using an ion exchange resin can be employed as an add-on process to existing plants that employ calcite dissolution using either CO_{2(g)} or H₂SO₄, a combination of both, or any other acidic substance.

Implementing the Process as an Add-On to a Post-Treatment Process that is Based on Calcite Dissolution Using CO_{2(g)}:

When CO₂-based calcite dissolution is implemented, the described process requires that the dissolution of calcite will result in Ca²⁺ ions in excess (i.e. a concentration higher than the requirement for Ca²⁺ in the product water). This excess Ca²⁺ concentration is subsequently replaced with Mg²⁺ in the Exchange step. Excess Ca²⁺ from the calcite reactor can be materialized by either increasing the CO₂ dose (or the percentage of treated water), or by the addition of a certain (relatively small) H₂SO₄ dose to the already implemented CO_{2(g)} dose. This process will typically require larger ion exchange columns (in comparison with the option that uses H₂SO₄ as the acidic substance, for a given split ratio) as well as longer Exchange steps.

An inherent advantage of the CO₂-based process over the H₂SO₄-based process is the possibility to elevate the pH (and CCPP) of the effluent of the ion exchange column (or the calcite dissolution reactor) by stripping of CO₂. Since the alkalinity of the calcite dissolution reactor effluent is high (relative to the alkalinity of the H₂SO₄-based dissolution) there is no need for an additional increase in the alkalinity value, and therefore the addition of NaOH can be replaced by CO₂ stripping. Apart from the mentioned differences, the CO₂-based process and the H₂SO₄-based process resemble each other in terms of their operational sequence.

Implementing the Process as an Add-On to a Post-Treatment Process that is Based on Ca(OH)₂ Dosage Followed by CO_{2(g)} Addition:

In this process, the ratio between the Ca²⁺ and alkalinity concentrations is by definition 1 to 1 (in meq/l units). Since the described process requires excess Ca²⁺ concentration relative to the Ca²⁺ concentration target (to be replaced with Mg²⁺ in the Exchange step), this excess concentration can be supplied by either dissolving more Ca(OH)₂ and CO_{2(g)}, or by dissolving a controlled mass of CaSO₄₍ₛ₎ (as an example) to the water. The latter option has the further advantage of SO₄²⁻ supply in the water. The excess Ca²⁺ concentration is replaced in the Exchange step with Mg²⁺. Otherwise the processes resemble each other in terms of their operational sequence.

### EXAMPLES RELATED TO THE OPERATION OF THE PROCESS

The following examples demonstrate how to attain two different sets of required water quality criteria using the proposed process. In the first example it is assumed that a continuous ion exchange mode is used. In the second example multiple column operation (stationary resin) is assumed. Multiple column operation is, in principal, similar to continuous operation, apart from the fact that the resin is stationary (it is subjected periodically to three different water streams in the Exchange, Load and Rinse cycles) and the water quality that leaves the post treatment process is not constant with time. A constant and average water quality can be attained by either installing a downstream storage tank, or in case the water flow rate is large, multiple ion exchange columns can be used, operated gradually with time. In the latter case the effluent streams from the columns are combined together in order to attain a final water quality with predetermined fluctuations in quality parameters' concentrations.

Note that in these two specific examples, the water quality requirements do not include a restriction on the total hardness (TH) concentration. If such a restriction is imposed, a second ion exchange resin should be installed with the aim of replacing excess Ca²⁺ ions with Na⁺ and/or K⁺ ions. Such resin should have a high affinity towards K⁺, Ca²⁺ and Na+ and a low affinity towards Mg²⁺. Such ion exchanger is, for example, Chabazite from the zeolite group (Lahav O. and Green M. (1998) Ammonium removal using ion exchange and biological regeneration. Wat. Res. 32(7): 2019-2028.

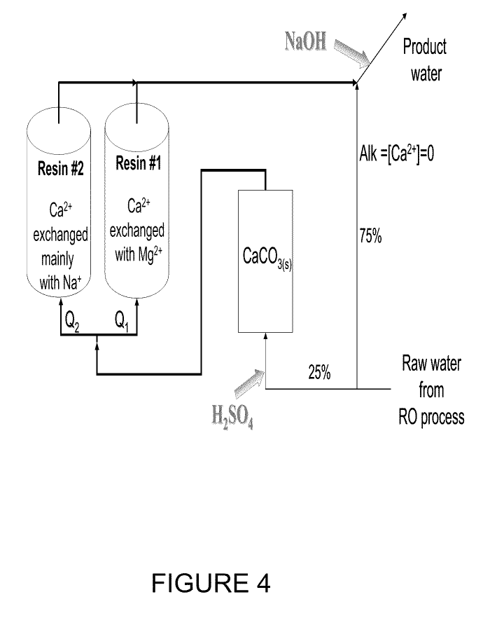

Reference is now made to FIG. 4 schematically illustrating an H₂SO₄ Calcite-dissolution-based desalination post treatment process operating in parallel to two sets of ion-exchange columns in accordance with yet another preferred embodiment of the present invention. The streams and process are similar to the process that is discussed in the description to FIG. 2; however, two resins are used in the process as shown herein instead of a single resin. The second resin that is used is the chabazite (resin #2), as an example, that is loaded with seawater in the Load step. When brought to equilibrium with seawater, chabazite absorbs mainly Na⁺ (66.8% of the total capacity) while Ca²⁺ is hardly absorbed (3.6%). In the exchange step, however, when water with high Ca2+ concentration is passed through it, the chabazite releases mainly Na⁺ in exchange for Ca2+ reducing through this the TH of the product water.

Optionally, water produced in the CO₂-based process is characterized by TH to alkalinity ratio of 1:1 or less, therefore this process can also be implemented when the required TH is limited.

### Operational Parameters Related to the Examples

Flow rate of RO desalination plant=14,000 m³/h (equivalent to the typical operative flow rate of a plant designed to supply 100,000,000 m³/year).
Total dissolved solids concentration in the water originating from the membrane separation process=30 mg/L.
Fraction of raw water that passes through the calcite reactor=25%.
Temperature=20° C.
CCPP assumed at the outlet of the calcite reactor=−25 mg/L as CaCO₃.

In these examples it was assumed that the post treatment reactors are sealed from the atmosphere, and therefore no release of CO₂ from the water to the atmosphere occurs.

### Example 1

### Continuous-Mode Operation

### Required Water Quality at Outlet of Post Treatment Process

Alkalinity>90 mg/L as CaCO₃
120≧[Ca²⁺]≧80 mg/L as CaCO₃
[Mg²⁺]=24.3 mg/L as Mg²⁺
CCPP≧3.0 mg/L as CaCO₃
pH=<8.5

### General Design

The required chemicals addition to the water when it passes through the calcite reactor is (assuming that only 25% of the water passes through the calcite reactor the chemical dosage per m³ of product water is 25% of these values):
H₂SO₄(100%)=500 mg/L (to pH 2.05)
CaCO₃₍ₛ₎=760 mg/L

According to the existing calcite dissolution process, this stream should have been recombined with 75% of untreated water and NaOH added to attain a pH value of around 7.78 to yield the following results: Alkalinity=92.5 mg/L as CaCO₃, [Ca²⁺]=190 mg/L as CaCO₃, and CCPP=3.1 mg/L as CaCO₃ (the NaOH dosage required in this scenario is 24 mg/L of product water).

In the suggested process, the water that leaves the calcite column has the following water quality parameters: Alkalinity=250 mg/L as CaCO₃, Ca²⁺=760 mg/L as CaCO₃, pH=6.57. This water is pumped into the “exchange zone” and is contacted with the resin so that 8 meq/L of CaCO₃ (i.e. 2 meq/L or 100 mg/L as CaCO₃ in the final product water after it is recombined with the split stream; see FIG. 3) are replaced by 8 meq/L of Mg²⁺ (i.e. following a 4:1 dilution [Mg²⁺]=2 meq/L or 24.3 mg Mg²⁺/L in the final product water).

The resulting water composition (following the blend with the split raw water stream (see FIG. 3), and NaOH dosage of 26.5 mg/L of product water) is: Alkalinity=95.6 mg/L as CaCO₃, [Ca²⁺]=90 mg/L as CaCO₃, [Mg²⁺]=24.3 mg/L, pH=8.19, and CCPP=3.2 mg/L as CaCO₃.

### Estimation of the Volume of Resin Required in the Continuous Ion Exchange Process (According to the Requirements Presented in the Example)

Using the specific resin Amberlite IRC747 (Rohm & Hass INC.), the hydraulic retention time required in the Exchange zone is between 1.5 and 2 minutes (i.e. 30 to 40 bed volumes per hour—manufacturer's data). Assuming that the flow rate into the calcite reactor is 3500 m³/h (25% of the hourly peak flow rate of a 100,000,000 m³/year desalination plant), the volume of resin in the Exchange zone should be around 100 m³ (3500 m³/h divided by 35 BV/h).

The volume of the resin in the “Load” zone is, under the conditions of this example, around 25% of the volume in the “Exchange zone” (i.e. around to 25 m³).
The volume of the resin in the “Rinse” zone in the example is expected not to exceed 10 m³. In total the volume of resin required under the conditions described in the example is around 135 m³.

### Example 2

### Multiple Column Operation

Required Water Quality at Outlet of Post Treatment Process
Alkalinity≧80 mg/L as CaCO₃
120>[Ca²⁺]≧80 mg/L as CaCO₃
[Mg²⁺]=12.15 mg/L
CCPP≧3.0 mg/L as CaCO₃
pH<8.5

The following example describes a case in which the process is implemented as an add-on to an existing plant that originally uses CO₂ as the sole acidifying agent. In order to supply water with the required TH (i.e. minimum 130 mg/l as CaCO₃) and alkalinity concentration that only slightly surpasses the lower threshold, H₂SO₄ is also added to the influent of the calcite reactor. Addition of H₂SO₄ is equivalent to a reduction of the alkalinity.

### General Design

The required chemical addition to the water when it passes through the calcite reactor is (assuming that 65% of the water passes through the calcite reactor):
H₂SO₄ (100%)=44.1 mg/L (to pH 3.07 and CCPP=−90 mg/l as CaCO₃ at the inlet of the calcite reactor).
CO₂ (100%)=80 mg/L (to CCPP=−227 mg/l as CaCO₃)
CaCO₃₍ₛ₎=200 mg/L

According to the existing calcite dissolution process, this stream should have been recombined with 35% of untreated water and NaOH added to attain a pH value of around 7.9 to yield the following results: Alkalinity=103.4 mg/L as CaCO₃, [Ca²⁺]=130 mg/L as CaCO₃, and CCPP=3.1 mg/L as CaCO₃ (the NaOH dosage required in this scenario is 14.8 mg/L).

In the suggested process, the water that leaves the calcite column (with the following water quality parameters: Alkalinity=130.6.3 mg/L as CaCO₃, Ca²⁺=200 mg/L as CaCO₃, pH=6.94) is pumped into the ion exchange columns and is contacted with the resin so that 1.5 meq/L of CaCO₃ (i.e. 1 meq/L or 50 mg/L as CaCO₃ in the final product water after it is recombined with the split stream; see FIG. 3) are replaced by 1.5 meq/L of Mg²⁺ (i.e. 1 meq/L or 12.15 mg Mg²⁺/L in the final product water).

The resulting water composition (following the blend with the split raw water stream—see FIG. 3, and NaOH dosage of 16.0 mg/L) is: Alkalinity=105.5 mg/L as CaCO₃, [Ca²⁺]=80 mg/L as CaCO₃, [Mg²⁺]=12.15 mg/L, pH=8.12 and CCPP=3.1 mg/L as CaCO₃.

Alternatively, it is possible to avoid NaOH dosage and raise the pH and the CCPP by CO₂ stripping. In such case, the resulting water quality (following the blend with the split raw water stream—see FIG. 3, and stripping of around 19 mg/L CO₂) would be: Alkalinity=84.9 mg/L as CaCO₃, [Ca²⁺]=80 mg/L as CaCO₃, [Mg²⁺]=12.15 mg/L, pH=8.27 and CCPP=3.1 mg/L as CaCO₃. Clearly, the alkalinity is lower and the pH is higher when CO₂ stripping is applied instead of NaOH addition.

Estimation of the Volume of Resin Required in the Multiple Column Ion Exchange Process (According to the Requirements Presented in this Example)

Using the same resin and flow rates as in example #1, the volume of resin in the Exchange step should also be the same, i.e. around 100 m³ (see example #1). The time a resin column spends in the “Load” step in this example is less than 5% of the time it spends in the “Exchange” step. The time a resin column spends in the “Wash” step in this example is expected not to exceed 1% of the time it spends in the “Exchange” step. Therefore, the volume of resin required in the load and rinse steps together amounts to around 6% of the amount in the exchange step. Thus, a total volume of 106 m³ resin is required in this example.

Accordingly, a typical design can assume 11 ion exchange columns, each with 10 m³ of resin: at all times 10 of the columns would be in the exchange step while one of the columns would be in the load/rinse step. A single ion exchange column will produce water at the beginning of the exchange step that is high in Mg²⁺ and low in Ca²⁺ and exactly the opposite at the end of the exchange step. However, under the suggested design, the 11 resin columns are operated at a time gap of around 1.39 h from each other. (The Exchange step” lasts 505 BV at a flow rate of 35 BV/h, i.e. a full cycle of single column would last 14.4 h, the Load step lasts 25 BV, which corresponds to 0.7 h and the Rinse step lasts around 0.14 h. a full cycle of operation lasts 15.3 h, and one-eleventh of it is 1.39 h). Under such an operational regime, the effluents of the ion exchange columns are mixed and the Mg²⁺ and Ca²⁺ concentrations in the final product water would change linearly with time during 1.39 hours repeating cycles from 2.53 to 2.67 meq/L ([Ca²⁺]) and from 1.46 to 1.33 meq/L ([Mg²⁺]).

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

What is claimed:

1. An H₂SO₄-based or CO₂-based calcite dissolution post-treatment process for water or any other cation-rich solution comprising:
separating cations from said water by at least one type of ion exchange resin onto which said ions are loaded; and
contacting said at least one ion exchange resin loaded with said cations with an effluent of a calcite reactor wherein said cations are exchanged with Ca²⁺ from said calcite reactor effluent,
wherein the Ca²⁺ concentration of the resulting desalinated water decreases while the cation concentration increases to comply with required quality criteria.

2. The process as claimed in claim 1, wherein the water is seawater, brackish or seawater desalination-process brine.

3. The process as claimed in claim 1, which further comprises rinsing said ion exchange resin with an internal desalination-plant water stream low in dissolved solids and draining it thereafter.

4. The process as claimed in claim 1, wherein said cations are Mg²⁺, K⁺ and Na⁺ and wherein Mg²⁺ ions are being exchanged in a first type ion exchange resin and Na⁺ and K⁺ ions in a second type ion exchange resin.

5. The process as claimed in claim 4, wherein said first type ion exchange resin has a high affinity towards divalent cations such as Mg²⁺ and Ca²⁺ and an extremely low affinity towards monovalent cations such as Na⁺ and K⁺.

6. The process as claimed in claim 4, wherein said second type ion exchange resin has a high affinity towards monovalent cations such as Na⁺ and K⁺ and a relatively low affinity towards divalent cations such as Ca²⁺ and Mg²⁺.

7. The process as claimed in claim 5, wherein said first type ion exchange resin is a resin such as Amberlite IRC747 (Rohm & Hass INC.) or equivalent.

8. The process as claimed in claim 1, wherein said water used to load the resin with cations is filtered water before it enters desalination process.

9. The process as claimed in claim 8, wherein the water used to load the resin with said cations is pre-filtered using sand filtration or UF membranes.

10. The process as claimed in claims 9, wherein said water that is used to load the resin is returned back to a container from where it was taken in a closed loop manner or discarded.

11. The process as claimed in claim 1, wherein the process is carried out in a batch ion-exchange mode.

12. The process as claimed in claim 1, wherein the process is carried out in a continuous ion exchange mode.

13. The process as claimed in claim 1, wherein the required quality criteria is Alkalinity (H₂CO₃* alkalinity) greater than 80 mg/L as CaCO₃; Ca²⁺ higher than 80; Calcium Carbonate Precipitation Potential between 3 and 10 mg/L as CaCO₃ and pH of less than 8.5.

14. The process as claimed in claim 1, wherein the process can be implemented in order to replace any certain fraction of the Ca²⁺ concentration generated by H₂SO₄- or CO₂-based calcite dissolution processes or a combination of both by an equivalent cations concentrations.
